(19) United States
(12) Patent Application Publication
(10) Pub. No.: US 2008/0041152 A1
(43) Pub. Date: Feb. 21, 2008

(54) FUEL LEVEL SENSOR APPARATUS

(76) Inventor: Gregory B. Schoenberg, Fenton, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/621,043

(22) Filed: Jan. 8, 2007

Related U.S. Application Data
(60) Provisional application No. 60/756,923, filed on Jan. 6, 2006.

(51) Int. Cl. G01F 23/00

(52) U.S. Cl. 73/295

(57) ABSTRACT

A fluid level sensor for a fluid storage tank including a mounting surface having a heating element mounted thereto, the heating element mounted in close proximity to a thermal sensor and a circuit for controlling power to the heating elements and receiving a signal from the thermal sensors sensing the change in temperature of the heating element to indicate whether or not the heating element is submersed in liquid, wherein the circuit intermittently energizes the heating element for a first period of time and de-energizes the heating element for a second period of time.

### CROSS-REFERENCE TO RELATED APPLICATIONS

The present application claims priority to U.S. Provisional Patent Application No. 60/756,923 filed Jan. 6, 2006, the contents of which are incorporated herein by reference.

### BACKGROUND OF THE INVENTION

The invention relates to fluid level sensors, and in particular to a non-mechanical solid state fluid level sensor for automobiles having no moving parts.

When driving an automobile, it is important that the driver know how much fuel remains within the gas tank so that he or she can refuel the vehicle before it runs out of fuel. Various types of level sensors are used to monitor the fuel level within the fuel tank and communicate the current level to the driver. The majority of these sensors utilize a mechanical action associated with a float or level disposed within the fuel tank. Mechanical sensors suffer from a variety of inadequacies, including sensitivity to fuel types, fuel sloshing and mechanical breakdowns.

Available level sensors fail to perform adequately enough to meet the standards in today's competitive auto industry. Currently available sensors are either not accurate enough or able to meet current quality standards under the broad range of operating conditions, such as temperature ranges, fuel types, and fuel sloshing, as is required by the industry.

Therefore, what is needed is a non-mechanical fuel level sensor that can accurately monitor and communicate the fuel level under the broad range of operating conditions that exist in automobiles.

### SUMMARY OF THE INVENTION

Briefly stated, the invention is a fuel sensor apparatus, comprising an external power source, a housing adapted for immersion within a fuel storage container, and at least one sensor array mounted within the housing. The sensor array comprises at least one microprocessor operatively connected to the power source, a plurality of thermal diodes operatively connected to the microprocessor, and at least one controlled heating element associated with each thermal diode. The microprocessor is configured to monitor an output signal from each of the thermal diodes in response to a heating or cooling cycle, with the output signal varying over time in response to immersion of the thermal diode within a liquid or fuel. By identifying whether a thermal diode is immersed in fuel or exposed to air, the fuel sensor apparatus of the present invention provides an indication of a fuel level within a fuel storage container.

The foregoing and other features, and advantages of the invention as well as embodiments thereof will become more apparent from the reading of the following description in connection with the accompanying drawings.

### DESCRIPTION OF THE DRAWINGS

In the accompanying drawings which form part of the specification:

FIG. 1 is a plan view of a level sensor apparatus in an extended position according to an embodiment of the present invention;

FIG. 2 is a plan view of the level sensor apparatus in a retracted position according to an embodiment of the present invention;

FIG. 3 is a perspective view of an upper half of the housing according to an embodiment of the present invention;

FIG. 4 is a side view of the upper half of the housing according to an embodiment of the present invention;

FIG. 5 is a perspective view of an upper flange of the housing according to an embodiment of the present invention;

FIG. 6 is another perspective view of the upper half of the housing according to an embodiment of the present invention;

FIG. 7 is an end view of the upper half of the housing according to an embodiment of the present invention;

FIG. 8 is a side view of the upper half of the housing according to an embodiment of the present invention;

FIG. 9 is a perspective view of the upper half of the housing with connectors attached to the flange according to an embodiment of the present invention;

FIG. 10 is a perspective view of the lower half of the housing according to an embodiment of the present invention;

FIG. 11 is another perspective view of the lower half of the housing according to an embodiment of the present invention;

FIG. 12 is a end view of the lower half of the housing according to an embodiment of the present invention;

FIG. 13 is a plan view of a sensor circuit board according to an embodiment of the present invention;

FIG. 14 is a side view of the sensor circuit board according to an embodiment of the present invention;

FIG. 15 is an enlarged view of the sensor circuit board according to an embodiment of the present invention;

FIG. 16 is a schematic of the sensor circuit board; according to an embodiment of the present invention

FIG. 17 is a graph illustrating the temperature response of a sensor during heating and cooling cycles according to an embodiment of the present invention;

FIG. 18 is a diagram of a sensor according to an embodiment of the present invention; and

FIG. 19 is a diagram of a sensor according to another embodiment of the present invention.

Corresponding reference numerals indicate corresponding parts throughout the several figures of the drawings.

### DETAILED DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

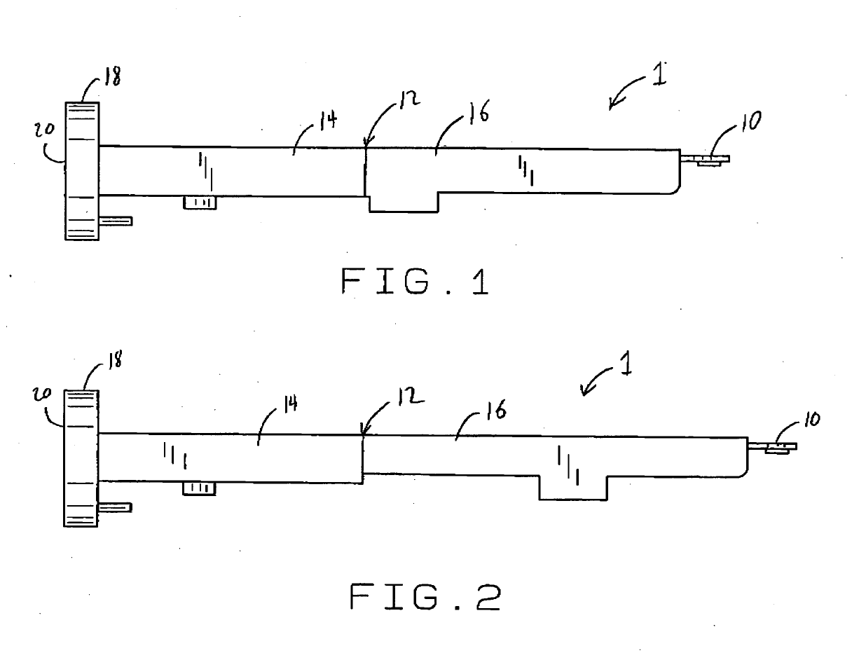

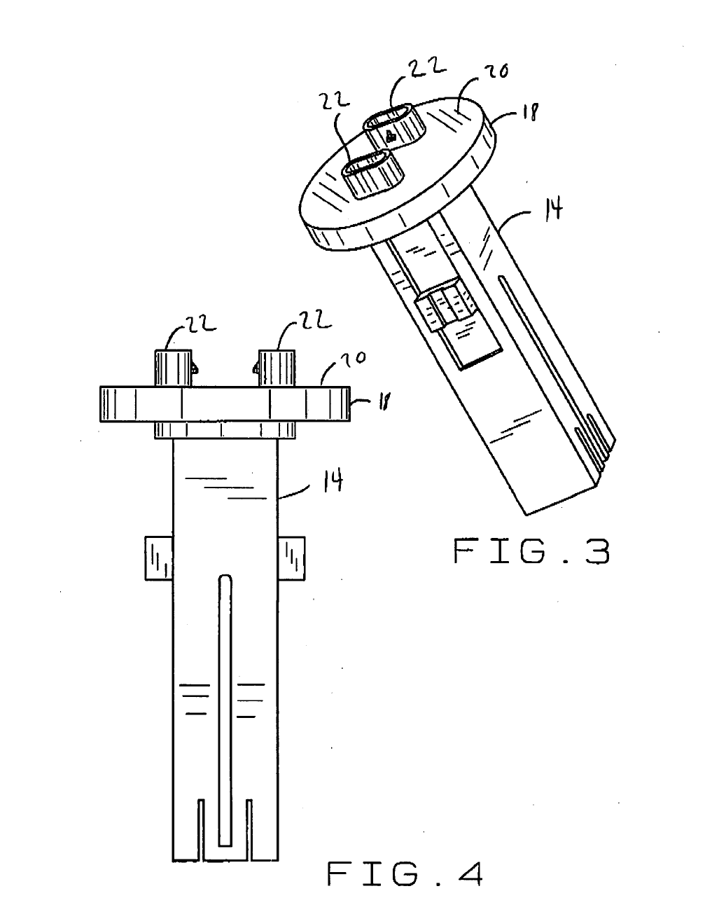

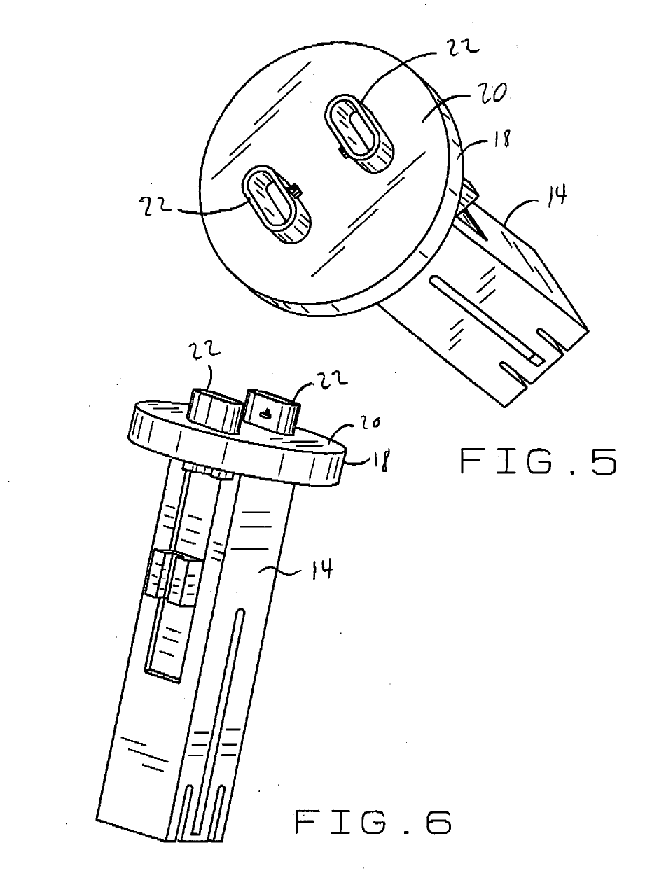

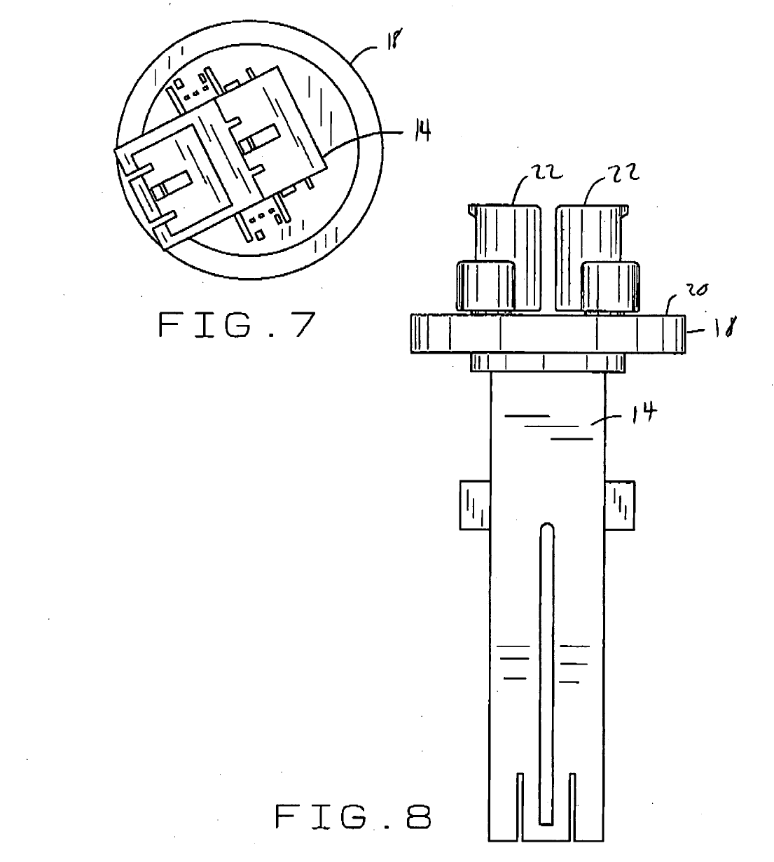

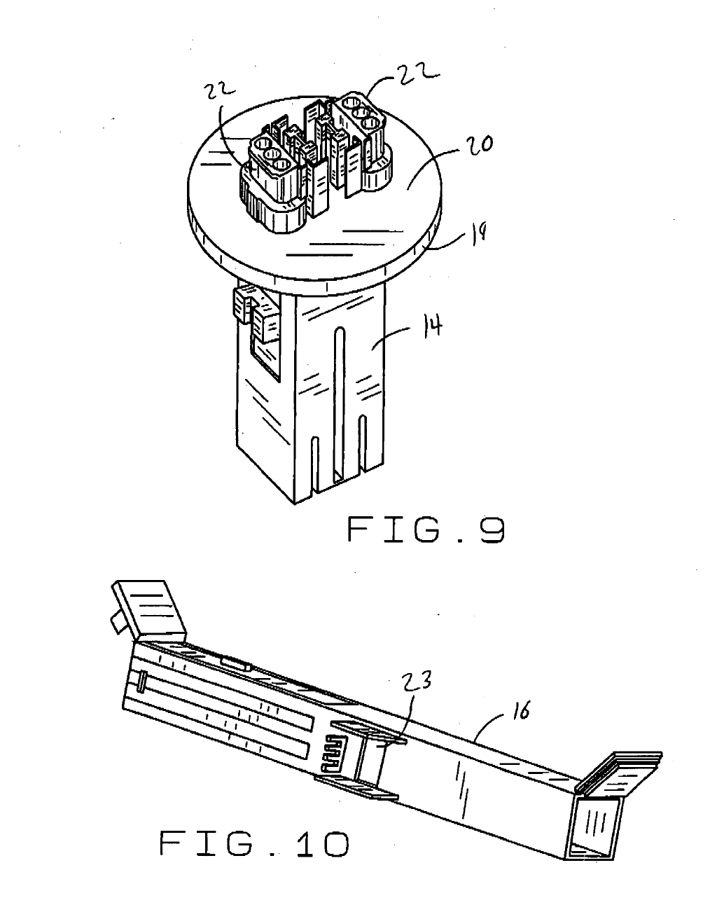

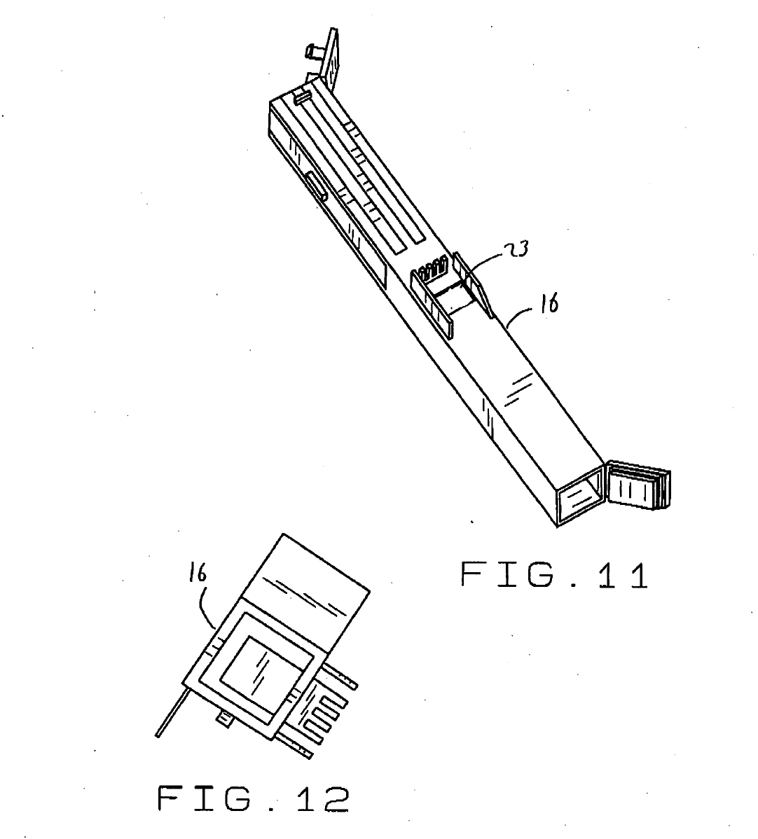

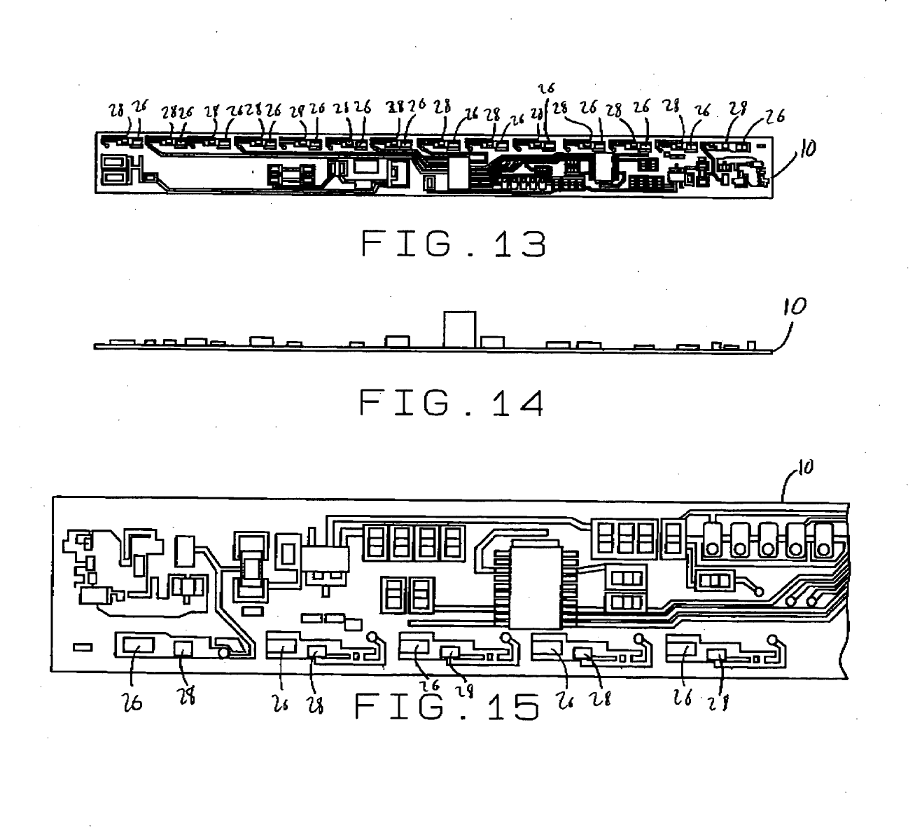

As shown in FIGS. 1-15, an embodiment of the present invention, generally referred to as a level sensor 1, includes a sensor circuit board 10 mounted within a housing 12.

The housing 12 comprises an upper half 14 and a lower half 16 that is slidably mounted within the upper half 14 so that the housing can be extended and retracted by sliding the lower half 16 within the upper half 14. The housing 12 includes a flange 18 at an upper end 20 of the upper half 14 that mounts to the top of a fuel tank and comprises electrical connections 22 that operatively connect to a power supply. The lower half 16 comprises an electrical connector opening 23.

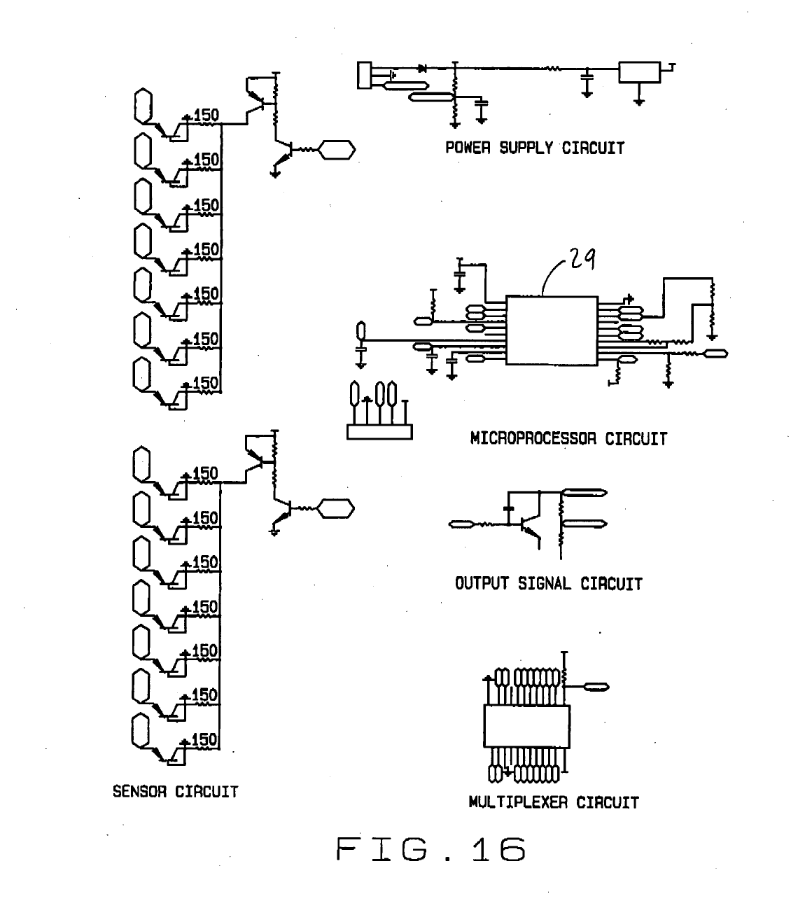

The sensor circuit board 10 mounts within the lower half 16 of the housing 12 and operatively connects to the electrical connections 22 of the upper half 14 of the housing 12 via a wiring harness. A plurality of discrete sensors 24 are mounted and spaced apart along the board in a linear fashion and operatively connected through a multiplexer to a microprocessor or other suitable logic circuit. The discrete sensors 24 each include a thermal diode 26 operatively connected to, and located in close proximity to, a controlled heating element 28 (shown diagrammatically in FIG. 18). The controlled heating element 28 is preferably a resistor. FIG. 16 is a schematic of the sensor circuit board.

In operation, the microprocessor or logic circuit 29 cycles the controlled heating elements 28 over a predetermined period of time, alternately heating and cooling the thermal diodes 26 of each discrete sensor 24. The output signal from each thermal diode 26, in the form of a voltage level, is sampled by the microprocessor or logic circuit over a period of time during the heating and/or cooling phase of the cycle to identify the change in temperature (ΔT) in response to the application or extraction of heat over a given period of time. Discrete sensors 24 which are immersed within the fuel stored in the fuel storage container will respond differently to the heating and cooling cycle as compared with those which are not. Accordingly, the value for ΔT for each discrete sensor 24 immersed within the fuel will differ from the value of ΔT for those discrete sensors which are not.

Accordingly, the microprocessor or logic circuit is configured to identify a level of fuel within the fuel storage container based upon a determination of which discrete sensors 24 are immersed in fuel and which are not. Preferably, the sensors 24 are arranged in a linear array, disposed vertically within the fuel storage container, however, those of ordinary skill in the art will recognize that the sensors need not be disposed in this manner, but rather, may be disposed as required about the fuel storage container, so as to accommodate any of a variety of container geometries.

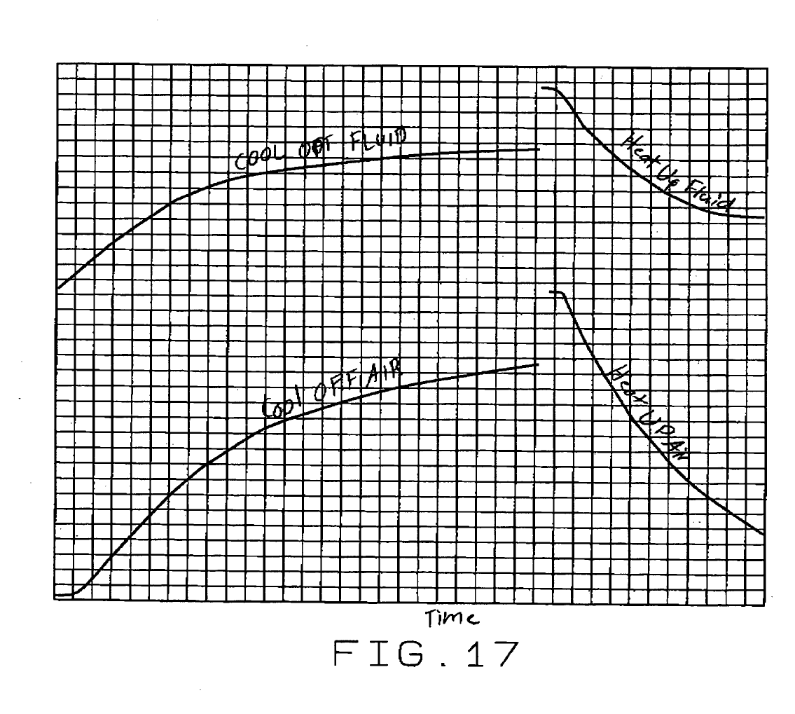

In the preferred embodiment, the temperature difference is greater when the sensor is exposed to air, as shown in FIG. 17.

While the sensors 24 are described above as thermal diode/resistor pairs, it should be understood by one of ordinary skill in the art that this arrangement is exemplary and the sensors may comprises any combination of a heating element and a heat sensing element. For example, the resistor may be omitted and merely a thermal diode used as by the heating element and a heat sensing element by utilizing the internal resistance of the thermal diode for heat generation, as diagrammatically illustrated in FIG. 19. Moreover, the thermal diode may comprise a NPN or PNP transistor wherein the base and collector are connected or simply by using a standard PN junction-type diode.

Moreover, the present invention can use the sensors 24 in any manner to determine the level of a liquid within a storage container, such as fuel within a fuel tank. Described above, the microprocessor investigates heating times in order to determine the sensors 24 that are submerged. However, one of ordinary skill in the art, from reading the present disclosure, would readily understand that one could also supply a voltage or current to the sensors 24 and determine absolute temperatures to determine fuel level or heating times and absolute temperatures could be used in alternating fashion, or a first method upon startup and a second method upon continued operation. For determining a fuel level based upon absolute temperature of the sensors 24, it may be advantageous to include reference sensors that are always submerged and/or always not submerged in order to determine the ambient temperature of the fuel and/or the air.

Furthermore, while it is described above to directly submerge the sensors, it has been found that coating the sensors and circuit board in a polymeric protective coating protects the device from the corrosive effects of certain liquids, for example, the corrosive effect of fuel containing 10% or more alcohol.

Changes can be made in the above constructions without departing from the scope of the invention, it is intended that all matter contained in the above description or shown in the accompanying drawings shall be interpreted as illustrative and not in a limiting sense.

I claim:

1. A fluid level sensor for a fluid storage tank comprising:
a mounting surface having a heating element mounted thereto, the heating element mounted in close proximity to a thermal sensor; and
a circuit for controlling power to the heating element and receiving a signal from the thermal sensors sensing the change in temperature of the heating element to indicate whether or not the heating element is submersed in liquid, wherein the circuit intermittently energizes the heating element for a first period of time and de-energizes the heating element for a second period of time.

2. The fluid level sensor of claim 1 wherein the heating element comprises a plurality of heating elements and the thermal sensor comprises a plurality of thermal sensors, the heating elements and the thermal sensors each mounted as pair in close proximity to one another, the heating elements and thermal sensors being distributed along the mounting surface

3. The fluid level sensor of claim 1 wherein the first period of time is shorter than the second period of time.

4. The fluid level sensor of claim 1 wherein the first period of time is equal to or longer than the second period of time.

5. The fluid level sensor of claim 1 wherein the circuit comprises a microprocessor for converting the signal received from the thermal sensor to a digital signal indicating a fluid level sensed by the sensor.

6. The fluid level sensor of claim 1 wherein the circuit comprises a microprocessor for converting the signal received from the thermal sensor to a pulse width modulated signal indicating a fluid level sensed by the sensor.

7. The fluid level sensor of claim 1 wherein the circuit comprises a microprocessor for converting the signal received from the thermal sensor to an analog DC output indicating a fluid level sensed by the sensor.

8. The fluid level sensor of claim 1 wherein the circuit comprises a circuit for simulating a variable resistance to provide an output signal.

9. The fluid level sensor of claim 1 further comprising a circuit for receiving a variable voltage input and outputting a constant voltage output to power the heating elements and thermal sensors.

10. The fluid level sensor of claim 2 wherein the heating elements are resistors.

11. The fluid level sensor of claim 2 wherein the thermal sensors are thermal diodes

12. The fluid level sensor of claim 1 wherein the circuit comprises a microprocessor for ceasing to alternatingly energize and de-energize at least some heating elements that are not determinative of the level of the fluid within the fluid storage tank.

13. The fluid level sensor of claim 1 wherein the circuit senses the change in temperature during the period during which the heating element is energized.

14. The fluid level sensor of claim 1 wherein the circuit senses the change in temperature during the period during which the heating element is deenergized.

15. The fluid level sensor of claim 1 wherein the circuit energizes the heating element at a greater power level upon initial startup.

16. The fluid level sensor of claim 1 wherein the heating element and the thermal sensor comprise a single circuit element.

17. A fluid level sensor for a fluid storage tank comprising:
a mounting surface having a plurality of heating elements mounted thereto, the heating elements each mounted in close proximity to a thermal sensor, the heating elements and thermal sensors being distributed along the mounting surface; and
a microprocessor for controlling power to the heating elements and receiving a signal from the thermal sensors to determine the change in temperature of the heating element to determine whether or not the heating element is submersed in liquid, wherein the circuit intermittently energizes the heating element for a first period of time and de-energizes the heating element for a second period of time.

18. The fluid level sensor of claim 17 wherein the first period of time is shorter than the second period of time.

19. The fluid level sensor of claim 17 further comprising a circuit for receiving a variable voltage input and outputting a constant voltage output to power the heating elements.

20. The fluid level sensor of claim 17 wherein the heating elements are resistors.

21. The fluid level sensor of claim 17 wherein the thermal sensors are thermal diodes

22. The fluid level sensor of claim 17 wherein the mounting surface is a printed circuit board.

23. The fluid level sensor of claim 17 wherein the circuit senses the change in temperature during the period during which the heating element is energized.

24. The fluid level sensor of claim 17 wherein the circuit causes energizes the heating element at a greater power level upon initial startup.

25. The fluid level sensor of claim 17 wherein the microprocessor further ceases to alternatingly energize and de-energize at least some heating elements that are not determinative of the level of the fluid within the fluid storage tank.

26. The fluid level sensor of claim 17 wherein each heating element/thermal sensor pair comprise a single circuit element.

27. A fluid level sensor for a fluid storage tank comprising:
a mounting surface having a plurality of heating elements mounted thereto, the heating elements each mounted in close proximity to a thermal sensor comprising a thermal diode, the heating elements and thermal sensors being distributed along the mounting surface;
a circuit for controlling power to the heating elements and receiving a signal from the thermal sensors to determine the change in temperature of the heating element to determine whether or not the heating element is submersed in liquid, wherein the circuit intermittently energizes the heating element for a first period of time and de-energizes the heating element for a second period of time.

28. The fluid level sensor of claim 27 wherein the first period of time is equal to or longer than the second period of time.

29. The fluid level sensor of claim 27 wherein the circuit comprises a microprocessor for converting the signal received from the thermal diode to a digital signal indicating to a fluid level sensed by the sensor.

30. The fluid level sensor of claim 27 wherein the circuit comprises a microprocessor for converting the signal received from the thermal diode to a pulse width modulated signal indicating a fluid level sensed by the sensor.

31. The fluid level sensor of claim 27 further comprising a circuit for receiving a variable voltage input and outputting a constant voltage output to power the heating elements and thermal sensors.

32. The fluid level sensor of claim 27 wherein the heating elements are resistors.

33. The fluid level sensor of claim 27 wherein the circuit comprises a microprocessor for ceasing to alternatingly energize and de-energize at least some heating elements that are not determinative of the level of the fluid within the fluid storage tank.

34. The fluid level sensor of claim 27 wherein each heating element/thermal sensor pair comprise a single circuit element.

35. A method of sensing the fluid level within a fluid storage tank comprising the steps of:
providing a plurality of pairs of heating elements and thermal sensing elements distributed vertically in the fluid storage tank;
alternately energizing and de-energizing the heating elements;
sensing one of the rate of heating and cooling of the thermal sensing elements;
determining whether each heating element is submerged in a liquid fluid based upon the rate of heating sensed by each thermal sensor; and
providing an output signal corresponding to the number of thermal sensing elements determined to be submerged in liquid fluid.

36. The method of claim 35 wherein the thermal sensing element is a thermal diode.

37. The method of claim 35 wherein a period of time wherein the heating elements are energized is shorter than a period of time during which the thermal elements are de-energized.

38. The method of claim 35 wherein a period of time wherein the heating elements are energized is longer than a period of time during which the thermal elements are de-energized.

39. The method of claim 35 further comprising the step of ceasing to alternatingly energize and de-energize at least some heating elements that are not determinative of the level of the fluid within the fluid storage tank.

40. The fluid level sensor of claim 35 wherein each of the heating element and thermal sensor pairs comprise a single circuit element.

41. A fluid level sensor for a fluid storage tank comprising:
a mounting surface having a plurality of heating elements mounted thereto, the heating elements each mounted in close proximity to a thermal diode, the heating elements and thermal diodes being distributed along the mounting surface; and
a microprocessor for controlling power to the heating elements and receiving a signal from the thermal diodes to determine the change in temperature of the heating element or thermal diode to determine whether or not the heating element or thermal diode is submersed in liquid.

42. The method of claim 41 wherein the circuit provides a higher power level to the heating elements when the circuit is initially energized.

43. The method of claim 41 wherein a period of time wherein the heating elements are energized is shorter than a period of time during which the thermal elements are de-energized.

44. The method of claim 41 wherein a period of time wherein the heating elements are energized is longer than a period of time during which the thermal elements are de-energized.

45. The method of claim 41 further comprising the step of ceasing to alternatingly energize and de-energize at least some heating elements that are not determinative of the level of the fluid within the fluid storage tank.

46. The fluid level sensor of claim 41 wherein the thermal diodes further comprise the heating element.
